(19) United States
(12) Patent Application Publication
(10) Pub. No.: US 2010/0039591 A1
(43) Pub. Date: Feb. 18, 2010

(54) CROSSLINKED PRODUCT, COLOR CORRECTION FILTER, OPTICAL ELEMENT, IMAGE DISPLAY, AND LIQUID CRYSTAL DISPLAY

(75) Inventors: Megumu Nagasawa, Ibaraki-shi (JP); Michie Sakamoto, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/526,531

(22) PCT Filed: Feb. 25, 2008
(86) PCT No.: PCT/JP2008/053150

§ 371 Date: Aug. 10, 2009

(30) Foreign Application Priority Data
Jul. 2, 2007 (JP) 2007-174007

(51) Int. Cl. G02F 1/1335; C08K 5/3432; C08K 5/353; C08K 5/17; C08K 5/3415; C08K 5/3437; C08K 5/47; G02B 5/23; G02B 5/22

(52) U.S. Cl. 349/106; 524/99; 524/94; 524/241; 524/105; 524/87; 524/83; 252/586; 359/885

(57) ABSTRACT

A crosslinked product with excellent durability is provided that can remove intermediate colors of light while preventing brightness from deteriorating and thereby can improve color tone representation. The crosslinked product of the present invention includes a J aggregate of a dye and is characterized in that the dye is at least one dye selected from the group consisting of cyanine, merocyanine, squarylium, and porphyrin, the J aggregate of the dye is formed in a matrix resin, and the matrix resin has been crosslinked.

### TECHNICAL FIELD

The present invention relates to crosslinked products, color correction filters, optical elements, image displays, and liquid crystal displays.

### BACKGROUND ART

Recently, a liquid crystal display in which light emitted from a light source unit such as a cold cathode tube or a light emitting diode (LED) is controlled by a liquid crystal panel to form images has been developed and has been put into practical use. In the liquid crystal display, in order to distribute the light from the light source unit over the whole display surface equally, a light guide plate is disposed on the optical path extending to the light source unit and in parallel with the liquid crystal panel so as to be placed thereon. The light source unit is disposed beside the light guide plate or on the opposite side of the light guide plate to the liquid crystal panel.

The configuration of a conventional liquid crystal display is shown in the cross-sectional view in FIG. 5. As shown in FIG. 5, this liquid crystal display has a liquid crystal panel 61, a cold cathode tube 64, and a light guide plate 65 as main components. The liquid crystal panel 61 has a structure in which a first polarizing plate 631 and a second polarizing plate 632 are disposed on both sides of a liquid crystal cell 62, respectively. The liquid crystal cell 62 is provided with a liquid crystal layer 640 in the center thereof. A first alignment film 651 and a second alignment film 652 are disposed on both sides of the liquid crystal layer 640, respectively. A first transparent electrode 661 and a second transparent electrode 662 are disposed on the outer sides of the first alignment film 651 and the second alignment film 652, respectively. Black matrices 690 and color filters 670 of, for example, R (red), G (green), and B (blue) with a predetermined arrangement are disposed on the outer side of the first transparent electrode 661, with a protective film 680 being interposed therebetween. A first substrate 601 and a second substrate 602 are disposed on the outer sides of the color filters 670 and the black matrices 690 and the second transparent electrode 662, respectively. In the liquid crystal panel 61, the first polarizing plate 631 side is a display side, and the second polarizing plate 632 side is a back side. The light guide plate 65 is disposed in parallel with the liquid crystal panel 61 so as to be placed thereon on the back side of the liquid crystal panel 61. The cold cathode tube 64 is disposed on the opposite side of the light guide plate 65 to the liquid crystal panel 61.

In this liquid crystal display, the light emitted from the cold cathode tube 64 is adjusted with the light guide plate 65 so that the in-plane brightness distribution may become uniform, and it is then transmitted to the second polarizing plate 632 side. Furthermore, after the outgoing light is controlled per pixel by the liquid crystal layer 640, only the light in predetermined wavelength ranges (for example, the respective wavelength ranges of R, G, and B) is transmitted through the color filters 670 and thereby a color display is obtained.

Normally, in order to display a color image in a liquid crystal display, at least three colors of light are required. Many color tones are represented according to the mixing degree of these three colors of light. At present, light of three primary colors of R, G, and B is used commonly for a liquid crystal display. With respect to the wavelength ranges corresponding to the three primary colors of light, R is in the range of about 610 to 750 nm, G in the range of about 500 to 560 nm, and B in the range of about 435 to 480 nm. The liquid crystal display is designed so that in light emitted from the light source unit (for example, a cold cathode tube) having an emission spectrum in a wide wavelength range, light other than that in necessary wavelength ranges is cut with color filters corresponding to the three primary colors of light, respectively, and thereby the three primary colors of light are obtained. The amount of light that enters each color filter is controlled by the respective components of the liquid crystal panel that are disposed on the light source unit side with respect to the color filter, and thereby the amount of light that is transmitted from each color filter is determined. Finally, the emission intensity and color tone per pixel unit of the liquid crystal display are determined through adjustment of the intensity of the three primary colors of light in pixels. Accordingly, an increase in color purity of the three primary colors of light in pixels results in a wider range of color tones formed through mixing of the three primary colors of light and therefore is more preferable.

However, in the conventional liquid crystal display, intermediate colors of light (for example, yellow light in a wavelength range between the wavelength ranges of R and G as well as light in a wavelength range between the wavelength ranges of G and B) other than R, G, and B are contained in the emission spectrum of the cold cathode tube, and they are not filtered out sufficiently with the color filters. As a result, there has been a problem in that the color tone of display image quality is deteriorated. Furthermore, when LEDs corresponding to three primary colors, R, G, and B, are used for a light source unit, excellent color tone representation is obtained but there have been problems in that a complicated control circuit is required and the cost also increases.

Furthermore, a liquid crystal display has been proposed in which white light is produced from light emitted from a blue LED and yellow light emitted from yttrium aluminum garnet (YAG), a fluorescent material, and is then used as a light source (pseudo white light source) (for example, see Patent Document 1). In this liquid crystal display, however, light emitted from the pseudo white light source contains more aforementioned intermediate colors of light as compared to a cold cathode tube. Accordingly, the liquid crystal display is poor in color tone representation.

On the other hand, a color correction filter has been proposed in which light in wavelength ranges of the intermediate colors is removed selectively (see Patent Documents 2 and 3). In this color correction filter, the light in the wavelength ranges of the intermediate colors is removed by being absorbed by a dye.
[Patent Document 1] JP 2004-117594 A
[Patent Document 2] JP 2000-321419 A
[Patent Document 3] JP 2000-258624 A

### DISCLOSURE OF INVENTION

However, the dye used in the aforementioned color correction filter is deteriorated and discolored due to, for instance, moisture, oxygen, or light. Accordingly, the color correction filter is poor in durability.

Therefore, the present invention is intended to provide a crosslinked product with excellent durability that can remove intermediate colors of light while preventing brightness from deteriorating and thereby can improve color tone representation.

In order to achieve the aforementioned object, the crosslinked product of the present invention includes a J aggregate of a dye,
wherein the dye is at least one dye selected from the group consisting of cyanine, merocyanine, squarylium, and porphyrin, and
the J aggregate of the dye is formed in a matrix resin and the matrix resin has been crosslinked.

The color correction filter of the present invention includes a color correction layer containing a crosslinked product, wherein the crosslinked product is the aforementioned crosslinked product of the present invention.

An optical element of the present invention includes a color correction filter, wherein the color correction filter is the aforementioned color correction filter of the present invention.

An image display of the present invention includes a color correction filter, wherein the color correction filter is the aforementioned color correction filter of the present invention.

A liquid crystal display of the present invention includes a color correction filter, wherein the color correction filter is the aforementioned color correction filter of the present invention.

An image display of the present invention includes an optical element, wherein the optical element is the aforementioned optical element of the present invention.

A liquid crystal display of the present invention includes an optical element, wherein the optical element is the aforementioned optical element of the present invention.

The crosslinked product of the present invention contains a J aggregate of a dye. Therefore, the use of the crosslinked product of the present invention makes it possible to remove intermediate colors of light while preventing brightness from deteriorating and thereby to improve color tone representation. Furthermore, in the crosslinked product of the present invention, the J aggregate of the dye is formed in a matrix resin and the matrix resin has been crosslinked. Accordingly, in the crosslinked product of the present invention, the J aggregate of the dye has an improved stability and excellent durability (for example, heat resistance, dark storage stability at room temperature, and light resistance). Therefore, the crosslinked product of the present invention makes it possible to maintain an improvement in color tone representation over a long period of time.

### BRIEF DESCRIPTION OF DRAWINGS

FIG. 1 is a graph showing examples of absorption spectra of a dye solution and a color correction layer according to an example of the present invention.

FIG. 2 is a cross-sectional view showing an example of the structure of a color correction filter according to the present invention.

FIG. 3 is a cross-sectional view showing an example of the structure of a liquid crystal display according to the present invention.

FIG. 4 is a cross-sectional view showing another example of the structure of the liquid crystal display according to the present invention.

FIG. 5 is a cross-sectional view showing an example of the structure of a conventional liquid crystal display.

FIG. 6 is a graph showing heat resistance evaluation results obtained in examples of the present invention.

### DESCRIPTION OF THE PREFERRED EMBODIMENTS

In the present invention, the expression “an improvement in color tone representation” embraces, for example, an improvement in color tone representation of R that is achieved by selectively absorbing light of yellow, an intermediate color between R and G, which affects the color tone representation of R, to remove it. This “improvement in color tone representation” results in, for example, an improvement in color purity of light of R.

The crosslinked product of the present invention is a matrix resin crosslinked product containing the J aggregate of the dye. In the crosslinked product of the present invention, it is preferable that the matrix resin be crosslinked at a temperature that is equal to or lower than the pyrolysis temperature of the J aggregate of the dye.

In the crosslinked product of the present invention, it is preferable that the matrix resin be a polymer that includes a hydroxyl group and the matrix resin have been crosslinked with the hydroxyl group and a crosslinker. In this case, the crosslinker is preferably at least one crosslinker selected from the group consisting of metal salt, boric acid, and a silane compound. The metal is preferably at least one metal selected from the group consisting of zinc, titanium, zirconium, iron, aluminum, and tin, and particularly preferably zinc.

In the crosslinked product of the present invention, examples of the matrix resin include polyvinyl alcohol (PVA), a polyethylene-PVA copolymer, a polyvinyl acetate-PVA copolymer, and a derivative of PVA.

In the crosslinked product of the present invention, the dye is preferably cyanine.

In the crosslinked product of the present invention, it is preferable that the cyanine be represented by at least one formula selected from the group consisting of the following general formulae (1) to (4).

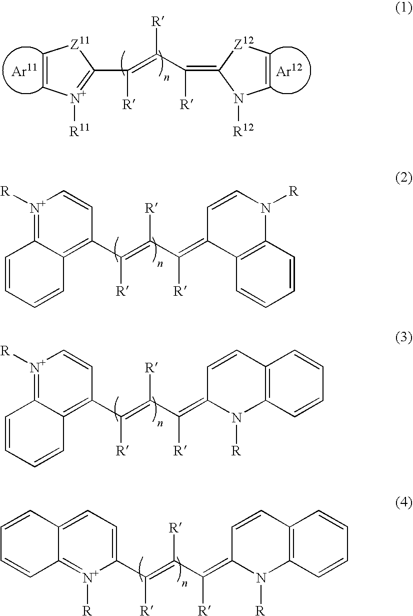

In general formula (1),

Z¹¹ and Z¹² each are —NH—, —CH₂—, —CH═CH—, or a heteroatom and may or may not have a substituent, and Z¹¹ and Z¹² may be identical to or different from each other. The aforementioned heteroatom is not particularly limited and examples thereof include S, Se, and O. The aforementioned substituent is not particularly limited and examples thereof include an alkyl group, a halogen atom, and an oxo group (═O). In Z¹¹ and Z¹², for example, at least one of hydrogen atoms (H) of —NH—, —CH₂—, and —CH═CH— may or may not be substituted by at least one of an alkyl group and a halogen atom.

Furthermore, in Z¹¹ and Z¹², for example, the S atom may or may not have an oxo group as a substituent and thereby may be SO or SO₂. A preferable example of the alkyl group is a linear or branched alkyl group with a carbon atom number of 1 to 12.

The rings Ar¹¹ and Ar¹² each may or may not have an unsaturated bond in a region other than a condensation portion formed with a nitrogen-containing ring, may or may not have aromaticity, may or may not have a heteroatom, and further may or may not have a substituent, and the rings Ar¹¹ and Ar¹² may be identical to or different from each other. The substituent is not particularly limited but at least one of, for example, an alkyl group and a halogen atom is preferable. A preferable example of the alkyl group is a linear or branched alkyl group with a carbon atom number of 1 to 12. The rings Ar¹¹ and Ar¹² are not particularly limited but, for example, 5- to 10-membered rings are preferable. More specific examples thereof include a benzene ring, a pyridine ring, and a naphthalene ring.

R¹¹ and R¹² each is a hydrogen atom or a linear or branched alkyl group, the alkyl group further may or may not be substituted by an ionic substituent, and R¹¹ and R¹² may be identical to or different from each other. A preferable example of the alkyl group is a linear or branched alkyl group with a carbon atom number of 1 to 18. The ionic substituent is not particularly limited but an anionic substituent is preferable, and it is preferable that the end of the alkyl group be substituted by the ionic substituent. The anionic substituent is not particularly limited and examples thereof include a sulfonic acid group and a carboxylic acid group. It is preferably a sulfonic acid group. More specifically, the alkyl group may be, for example, a sulfoalkyl group whose end has been substituted by a sulfo group or a carboxyalkyl group whose end has been substituted by a carboxy group. Furthermore, the counter ion of the aforementioned ionic substituent is not particularly limited. When the ionic substituent is an anionic substituent, examples of the counter ion (cation) include a hydrogen ion, a metal ion, and an ammonium ion. Moreover, for example, N⁺ itself in formulae (1) to (4) described above may be a counter ion of the anionic substituent. The aforementioned metal ion is not particularly limited and examples thereof include an alkali metal ion, an alkaline earth metal ion, and a transition metal ion. Examples of the alkali metal ion include Li⁺, Na⁺, K⁺, Rb⁺, and Cs⁺. Examples of the alkaline earth metal ion include Be²⁺, Mg²⁺, Ca²⁺, Sr²⁺, and Ba²⁺. The ammonium ion is not particularly limited and examples thereof include NH₄⁺ and an alkylammonium ion. The alkylammonium ion is not particularly limited and examples thereof include a tetramethylammonium ion, a trimethylammonium ion, a tetraethylammonium ion, and a triethylammonium ion.

In general formulae (2) to (4),

R is a hydrogen atom or a linear or branched alkyl group, and the respective Rs may be identical to or different from each other. A preferable example of the alkyl group is a linear or branched alkyl group with a carbon atom number of 1 to 12.

In general formulae (1) to (4),

R′ is a hydrogen atom, a linear or branched alkyl group, or an aromatic group, the alkyl group is preferably a linear or branched alkyl group with a carbon atom number of 1 to 18, and the respective R′s may be identical to or different from each other, and

n is 0 or any positive integer, n is preferably, for example, 0, 1, or 2.

Furthermore, in general formulae (1) to (4), the counter ion (anion) of N⁺ is not particularly limited and it may be a monovalent anion or a polyvalent anion and may be of one type or a plurality of types. The monovalent anion is not particularly limited and examples thereof include a halide ion, a hypohalogenous acid ion, a halogenous acid ion, a halogen acid ion, a perhalogen acid ion, a nitric acid ion, a nitrite ion, a hexafluorophosphate ion (PF₆⁻), and a trifluoromethanesulfonate ion (CF₃COO⁻). At least one selected from the group consisting of F⁻, Cl⁻, Br⁻, I⁻, and ClO₄⁻ is particularly preferable. The polyvalent anion is not particularly limited and examples thereof include a sulfate ion and a sulfite ion.

In the present invention, the “halogen” refers to any halogen element and examples thereof include fluorine, chlorine, bromine, and iodine. In the present invention, the “alkyl group” is not particularly limited. Examples of the alkyl group include a methyl group, an ethyl group, an n-propyl group, an isopropyl group, an n-butyl group, an isobutyl group, a sec-butyl group, a tert-butyl group, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, a nonadecyl group, and an icosyl group. The same applies to a group including an alkyl group in its structure or a group derived from an alkyl group (a sulfoalkyl group, a carboxyalkyl group, or an alkoxy group). Furthermore, when, for example, a substituent is a group having a chain structure (for example, an alkyl group, a sulfoalkyl group, a carboxyalkyl group, or an alkoxy group), it may be in the linear or branched form unless it is particularly limited. Moreover, when, for example, a substituent has an isomer, it can be any isomer unless it is particularly limited. For example, in the case where simply the term “propyl group” is used, it may be either an n-propyl group or an isopropyl group. In the case where simply the term “butyl group” is used, it may be any one of an n-butyl group, an isobutyl group, a sec-butyl group, and a tert-butyl group. In the case where simply the term “naphthyl group” is used, it may be either a 1-naphthyl group or a 2-naphthyl group.

In the crosslinked product of the present invention, it is preferable that the cyanine be represented by at least one selected from the group consisting of the following structural formulae (5) to (7).

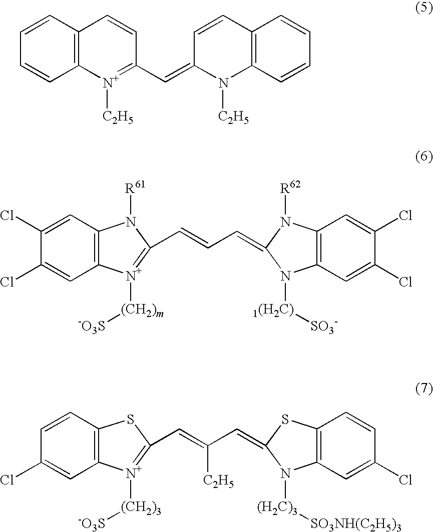

In structural formula (6),

R⁶¹ and R⁶² each is a hydrogen atom or a linear or branched alkyl group, the alkyl group is preferably a linear or branched alkyl group with a carbon number of 4 or less, and R⁶¹ and R⁶² may be identical to or different from each other.

Furthermore, m and l each are any positive integer, preferably 1 to 4, and m and l may be identical to or different from each other.

Structural formula (5) is a preferable form of general formula (4) described above, and structural formulae (6) and (7) are preferable forms of general formula (1) described above. Accordingly, in structural formulae (5) and (6), for example, the counter ion is the same as in general formulae (1) to (4). In structural formula (6), the counter ion of one sulfonate ion (—SO₃—) is N⁺ in structural formula (6). The counter ion of the other sulfonate ion (—SO₃—) is not particularly limited but preferably, for example, an alkali metal ion, and at least one selected from the group consisting of Li⁺, Na⁺, and K⁺ is particularly preferable. Furthermore, a compound (ion) represented by structural formula (6) described above is particularly preferably a compound (ion) represented by the following structural formula (8).

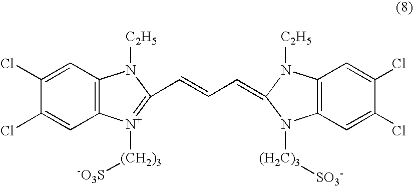

The color correction filter of the present invention includes a color correction layer containing the aforementioned crosslinked product of the present invention. In the color correction filter of the present invention, it is preferable that the half bandwidth at the maximum absorption peak of the color correction layer be in the range of 5 to 30 nm. In the present invention, the half bandwidth at the maximum absorption peak of the color correction layer denotes the difference in wavelength between two points that indicate half values of the maximum absorbance at the maximum absorption peak of the color correction layer. The half bandwidth can be determined, for example, from the maximum absorption peak of the color correction layer that is obtained by measuring the absorption spectrum of the color correction layer with an ultraviolet-visible spectrophotometer as described later in examples. Since the half bandwidth is in the above-mentioned range, the color correction layer can remove intermediate colors of light selectively without absorbing light (for instance, light of R) in the wavelength ranges that are required for color tone representation.

In the color correction filter of the present invention, it is preferable that the wavelength of the maximum absorption peak of the color correction layer be in the range of 560 to 610 nm.

In the color correction filter of the present invention, it is preferable that the maximum absorbance of the color correction layer in the wavelength range of 560 to 610 nm be at least 0.2.

In the color correction filter of the present invention, the thickness of the color correction layer be preferably in the range of 10 to 500 nm, more preferably in the range of 30 to 400 nm, and further preferably in the range of 50 to 300 nm.

In the color correction filter of the present invention, it further may include a base material and the color correction layer may be formed on at least one surface of the base material.

Hereinafter, the present invention is described in detail.

The crosslinked product of the present invention contains a J aggregate of a dye.

The “J aggregate” has a one-dimensional structure in which, for example, a plurality of dye molecules aggregate perpendicularly to the direction of transition moment thereof (head-to-tail) and the deviation angle between the dye molecules is small (approximately 80° or smaller). The J aggregate of the dye is characterized in that the light absorption band in the visible light range shifts to the longer wavelength side and has a reduced width as compared to the case where the dye is one molecule. The shift amount is in the range of, for example, 30 to 60 nm. Furthermore, the half bandwidth at the maximum absorption peak of the aforementioned J aggregate is, for example, 30 nm or less. The “J aggregate” refers to, for example, one described in T. Kobayashi, “J-Aggregates”, World Scientific (1996).

Examples of the dye that forms the “J aggregate” include cyanine, merocyanine, squarylium, and porphyrin.

The aforementioned cyanine is a dye having a structure in which two nitrogen-containing heterocycles are bonded to each other with an odd number of methine groups. Nitrogen contained in one of the aforementioned two nitrogen-containing heterocycles is tertiary amine, and nitrogen contained in the other nitrogen-containing heterocycle is quaternary ammonium. The cyanine is represented by, for example, general formulae (1) to (4) described above. In a narrow sense, for example, a compound where n=0 in formula (2) may be referred to as “cyanine”, a compound where n=0 in formula (3) as “isocyanine”, and a compound where n=0 in formula (4) as “pseudocyanine”. In the present invention, however, as described above, the “cyanine” is a generic term for dyes in which two nitrogen-containing heterocycles are bonded to each other with an odd number of methine groups, and nitrogen contained in one nitrogen-containing heterocycle is tertiary amine, and nitrogen contained in the other nitrogen-containing heterocycle is quaternary ammonium.

Specific examples of cyanine represented by general formula (1) are indicated in Table 1 below. Cyanines of this example are represented by general formula (1-2) indicated above Table 1, and more specifically, they are represented by Compound Nos. 1-2-1 to 1-2-8 indicated in Table 1.

TABLE 1

| | |
|---|---|
| | (1-2) |
| 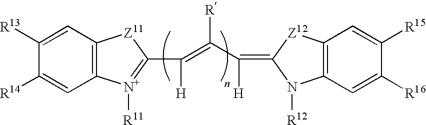 | |

| Com- | | | | | | | | | | | |
|---|---|---|---|---|---|---|---|---|---|---|---|
| pound | | | | | | | | | | | Counter |
| No. | Z¹¹ | Z¹² | R¹¹ | R¹² | R¹³ | R¹⁴ | R¹⁵ | R¹⁶ | R′ | n | Ion |
| 1-2-1 | O | O | —(CH₂)₂COO⁻ | —(CH₂)₂COOH | H | H | H | H | H | 1 | None |
| 1-2-2 | O | O | —(CH₃)₃COOH | —(CH₂)₂COOH | H | H | H | H | H | 1 | F⁻, Cl⁻, Br⁻, I⁻, |
| | | | | | | | | | | | CF₃COO⁻, or |
| | | | | | | | | | | | PF₆⁻ |
| 1-2-3 | O | O | —(CH₂)₂COO⁻ | —(CH₂)₂COOH | H | H | H | H | H | 2 | None |
| 1-2-4 | O | O | —(CH₂)₂COOH | —(CH₂)₂COOH | H | H | H | H | H | 2 | F⁻, Cl⁻, Br⁻, I⁻, |
| | | | | | | | | | | | CF₃COO⁻, or |
| | | | | | | | | | | | PF₆⁻ |
| 1-2-5 | S | S | —(CH₂)₂COOH | —(CH₂)₂COOH | H | H | H | H | —CH₂CH₃ | 1 | F⁻, Cl⁻, Br⁻, I⁻, |
| | | | | | | | | | | | CF₃COO⁻, or |
| | | | | | | | | | | | PF₆⁻ |
| 1-2-6 | S | S | —CH₂COOH | —CH₂COOH | H | H | H | H | —CH₂CH₃ | 1 | F⁻, Cl⁻, Br⁻, I⁻, |
| | | | | | | | | | | | CF₃COO⁻, or |
| | | | | | | | | | | | PF₆⁻ |
| 1-2-7 | S | S | —(CH₂)₂COOH | —(CH₂)₂COOH | H | H | H | H | H | 2 | F⁻, Cl⁻, Br⁻, I⁻, |
| | | | | | | | | | | | CF₃COO⁻, or |
| | | | | | | | | | | | PF₆⁻ |
| 1-2-8 | C(CH₃)₂ | C(CH₃)₂ | —(CH₂)₂COOH | —(CH₂)₂COOH | H | H | H | H | —CH₂CH₃ | 1 | F⁻, Cl⁻, Br⁻, I⁻, |
| | | | | | | | | | | | CF₃COO⁻, or |
| | | | | | | | | | | | PF₆⁻ |

The merocyanine is a nonionic dye and is represented by, for example, the following general formula (9).

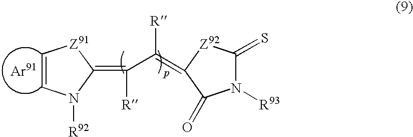

In general formula (9),

Z91 and Z⁹² each are —NH—, —CH₂—, —CH═CH—, or a heteroatom and may or may not have a substituent, and Z⁹¹ and Z⁹² may be identical to or different from each other. The aforementioned heteroatom is not particularly limited and examples thereof include S, Se, and O. The aforementioned substituent is not particularly limited and examples thereof include an alkyl group, a halogen atom, and an oxo group (═O). In Z⁹¹ and Z⁹², for example, at least one of hydrogen atoms (H) of —NH—, —CH₂—, or —CH═CH— may be substituted by at least one of an alkyl group and a halogen atom. Furthermore, in Z⁹¹ and Z⁹², for example, the S atom may have an oxo group as a substituent and thereby may be SO or SO₂. A preferable example of the alkyl group is a linear or branched alkyl group with a carbon atom number of 1 to 10.

The ring Ar⁹¹ may or may not have an unsaturated bond in a region other than a condensation portion formed with a nitrogen-containing ring, may or may not have aromaticity, may or may not have a heteroatom, and further may or may not have a substituent. The substituent is not particularly limited but at least one of, for example, an alkyl group and a halogen atom is preferable. A preferable example of the alkyl group is a linear or branched alkyl group with a carbon atom number of 1 to 12. The ring Ar⁹¹ is not particularly limited but, for example, 5- to 10-membered rings are preferable. More specific examples thereof include a benzene ring, a pyridine ring, and a naphthalene ring.

R⁹² and R⁹³ each is a hydrogen atom or a linear or branched alkyl group, the alkyl group further may or may not be substituted by an ionic substituent, and R⁹² and R⁹³ may be identical to or different from each other. A preferable example of the alkyl group is a linear or branched alkyl group with a carbon atom number of 1 to 20. The ionic substituent is not particularly limited but an anionic substituent is preferable, and it is preferable that the end of the alkyl group be substituted by the ionic substituent. The anionic substituent is not particularly limited and examples thereof include a sulfonic acid group and a carboxylic acid group. More specifically, the alkyl group may be, for example, a sulfoalkyl group whose end has been substituted by a sulfo group or a carboxyalkyl group whose end has been substituted by a carboxy group. Furthermore, the counter ion of the aforementioned ionic substituent is not particularly limited. When the ionic substituent is an anionic substituent, examples of the counter ion (cation) include a hydrogen ion, a metal ion, and an ammonium ion. The aforementioned metal ion is not particularly limited and examples thereof include an alkali metal ion, an alkaline earth metal ion, and a transition metal ion. Examples of the alkali metal ion include Li⁺, Na⁺, K⁺, Rb⁺, and Cs⁺. Examples of the alkaline earth metal ion include Be²⁺, Mg²⁺, Ca²⁺, Sr²⁺, and Ba²⁺. The ammonium ion is not particularly limited and examples thereof include NH₄⁺ and an alkylammonium ion. The alkylammonium ion is not particularly limited and examples thereof include a tetramethylammonium ion, a trimethylammonium ion, a tetraethylammonium ion, and a triethylammonium ion.

R″ is a hydrogen atom, a halogen atom, or a linear or branched alkyl group, the alkyl group is preferably a linear or branched alkyl group with a carbon atom number of 1 to 10, and the respective R″s may be identical to or different from each other.

Furthermore, p is any positive integer, for example, 1 to 3.

Specific examples of merocyanine represented by general formula (9) are indicated in Table 2 below. Merocyanines of this example are represented by general formula (9-2) indicated above Table 2, and more specifically, they are represented by Compound Nos. 9-2-1 to 9-2-16 indicated in Table 2.

TABLE 2

| | |
|---|---|
| | (9-2) |
| 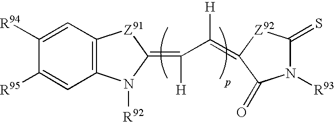 | |

| Compound | | | | | | | |
|---|---|---|---|---|---|---|---|
| No. | Z⁹¹ | Z⁹² | R⁹² | R⁹³ | R⁹⁴ | R⁹⁵ | p |
| 9-2-1 | S | S | —(CH₂)₁₇CH₃ | —CH₂COOH | H | H | 1 |
| 9-2-2 | S | S | —(CH₂)₁₇CH₃ | —CH₂COOH | —CH₃ | H | 1 |
| 9-2-3 | S | S | —(CH₂)₁₇CH₃ | —CH₂COOH | —CH₂CH₃ | H | 1 |
| 9-2-4 | S | S | —(CH₂)₁₇CH₃ | —CH₂COOH | —(CH₂)₂CH₃ | H | 1 |
| 9-2-5 | Se | S | —(CH₂)₁₇CH₃ | —CH₂COOH | H | H | 1 |
| 9-2-6 | Se | S | —(CH₂)₁₇CH₃ | —CH₂COOH | —CH₃ | H | 1 |
| 9-2-7 | Se | S | —(CH₂)₁₇CH₃ | —CH₂COOH | —CH₂CH₃ | H | 1 |
| 9-2-8 | Se | S | —(CH₂)₁₇CH₃ | —CH₂COOH | —(CH₂)₂CH₃ | H | 1 |
| 9-2-9 | S | S | —(CH₂)₁₇CH₃ | —(CH₂)₂COOH | H | H | 1 |
| 9-2-10 | S | S | —(CH₂)₁₇CH₃ | —(CH₂)₂COOH | —CH₃ | H | 1 |
| 9-2-11 | S | S | —(CH₂)₁₇CH₃ | —(CH₂)₂COOH | —CH₂CH₃ | H | 1 |
| 9-2-12 | S | S | —(CH₂)₁₇CH₃ | —(CH₂)₂COOH | —(CH₂)₂CH₃ | H | 1 |
| 9-2-13 | Se | S | —(CH₂)₁₇CH₃ | —(CH₂)₂COOH | H | H | 1 |
| 9-2-14 | Se | S | —(CH₂)₁₇CH₃ | —(CH₂)₂COOH | —CH₃ | H | 1 |
| 9-2-15 | Se | S | —(CH₂)₁₇CH₃ | —(CH₂)₂COOH | —CH₂CH₃ | H | 1 |
| 9-2-16 | Se | S | —(CH₂)₁₇CH₃ | —(CH₂)₂COOH | —(CH₂)₂CH₃ | H | 1 |

The aforementioned squarylium is represented by the following general formula (10).

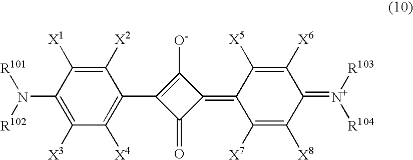

In general formula (10), R¹⁰¹ to R¹⁰⁴ each are an alkyl group and is preferably a linear or branched alkyl group with a carbon number of 6 or less, and R¹⁰¹ to R¹⁰⁴ may be identical to or different from each other. X¹ to X⁸ each are a hydrogen atom, a halogen atom, an alkyl group, an alkoxy group, or a hydroxyl group, the alkyl group is particularly preferably a methyl group or an ethyl group, and the alkoxy group is particularly preferably a methoxy group. X¹ to X⁸ may be identical to or different from each other.

The aforementioned porphyrin is a macrocyclic compound in which four pyrrole rings are bonded to four methine groups alternately at the site α, and a derivative thereof. It is represented by, for example, the following general formula (11).

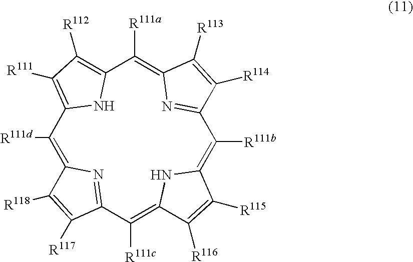

In formula (11), R¹¹¹ to R¹¹⁸ and R^{111a} to R^{111d} each are an alkyl group, a hydrogen atom, or a phenyl group, the alkyl group is preferably a linear or branched alkyl group with a carbon number of 4 or less, and R¹¹¹ to R¹¹⁸ may be identical to or different from one another. In R¹¹¹ to R¹¹⁸, the phenyl group may or may not have a substituent. The substituent is not particularly limited but is preferably at least one selected from the group consisting of an alkyl group, a halogen atom, a sulfo group, and a carboxyl group. The alkyl group is more preferably, for example, a linear or branched alkyl group with a carbon atom number of 1 to 12.

Furthermore, the porphyrin may be a porphyrin complex having coordination metal in its center. The coordination metal is not particularly limited and examples thereof include ions of zinc, iron, cobalt, ruthenium, or gallium, more specifically, for example, Zn(II), Ga(III), Fe(II), Fe(III), Co(II), Co(III), Ru(II), and Ru(III). The coordination metal is not limited to only metal ions but may be, for example, metal halide, metal oxide, metal hydroxide, Si, Ge, or P.

One of those dyes above may be used independently or two or more of them may be used in combination. Furthermore, those dyes may be used as a complex of, for example, nickel, copper, cobalt, or iron in order to improve fastness thereof.

Particularly preferably, the dye of the present invention is at least one selected from the group consisting of, for example, cyanine represented by any one of structural formulae (5) to (8) described above and merocyanine represented by the following structural formula (12) or (13).

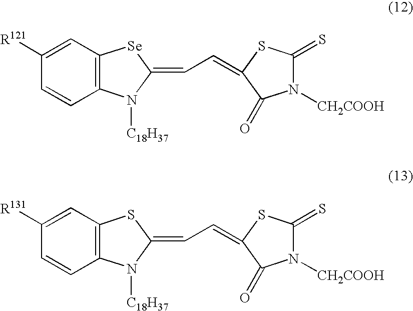

In formulae (12) and (13), R¹²¹ and R¹³¹ each is a hydrogen atom or a linear or branched alkyl group. A preferable example of the alkyl group is a linear or branched alkyl group with a carbon atom number of 1 to 12. Furthermore, in structural formulae (12) and (13), each —C₁₈H₃₇ (octadecyl group) may be in the linear or branched form but is preferably in the linear form.

Specific examples of cyanines represented by structural formula (6) are indicated in Table 3 below. Cyanines of this example are represented by Compound Nos. 6-1 to 6-8 indicated in Table 3.

TABLE 3

| | |
|---|---|
| | (6) |
| 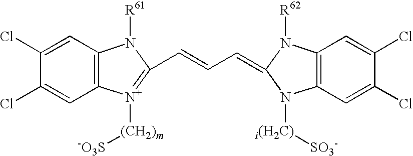 | |

| Compound | | | | | |
|---|---|---|---|---|---|
| No. | R⁶¹ | R⁶² | m | 1 | Counter Ion |
| 6-1 | —CH₃ | —CH₃ | 1 | 1 | Li⁺, Na⁺, or K⁺ |
| 6-2 | —CH₃ | —CH₃ | 2 | 2 | Li⁺, Na⁺, or K⁺ |
| 6-3 | —CH₃ | —CH₃ | 3 | 3 | Li⁺, Na⁺, or K⁺ |
| 6-4 | —CH₂CH₃ | —CH₂CH₃ | 1 | 1 | Li⁺, Na⁺, or K⁺ |
| 6-5 | —CH₂CH₃ | —CH₂CH₃ | 2 | 2 | Li⁺, Na⁺, or K⁺ |
| 6-6 | —(CH₂)₂CH₃ | —(CH₂)₂CH₃ | 1 | 1 | Li⁺, Na⁺, or K⁺ |
| 6-7 | —(CH₂)₂CH₃ | —(CH₂)₂CH₃ | 2 | 2 | Li⁺, Na⁺, or K⁺ |
| 6-8 | —(CH₂)₂CH₃ | —(CH₂)₂CH₃ | 3 | 3 | Li⁺, Na⁺, or K⁺ |

As described above, the J aggregate of the dye has been formed in a matrix resin and the matrix resin has been crosslinked. In the crosslinked product of the present invention, therefore, the J aggregate of the dye has an improved stability and excellent durability (for example, heat resistance, dark storage stability at room temperature, and light resistance).

As described above, in the crosslinked product of the present invention, it is preferable that the matrix resin be a polymer that includes a hydroxyl group and the matrix resin have been crosslinked with the hydroxyl group and a crosslinker. In this case, preferable crosslinkers to be used are one that salt-bridges the hydroxyl group and one that forms a chemical bond with the hydroxyl group. The crosslinker is preferably at least one crosslinker selected from the group consisting of metal salt, boric acid, and a silane compound. Examples of the metal salt include halide (for example, chloride and iodide) of metal, sulfate of metal, acetate of metal, and metal alkoxide. Examples of the alkoxide include methoxide, ethoxide, n-propoxide, isopropoxide, and sec-butoxide. Examples of the silane compound include tetraethoxysilane, tetramethoxysilane, and tetraphenoxysilane. Examples of the metal include zinc, titanium, zirconium, iron, aluminum, and tin. Particularly preferably, the metal is zinc. That is, it is particularly preferable that the crosslinker be zinc salt and specific examples of the zinc salt include zinc halides such as zinc chloride and zinc iodide, zinc sulfate, and zinc acetate.

In the crosslinked product of the present invention, the matrix resin is not particularly limited but is preferably one with excellent visible light transmittance (preferably with a light transmittance of at least 90%) and excellent transparency (preferably with a haze value of 1% or lower). Furthermore, the matrix resin is preferably a polymer that includes a hydroxyl group. When the matrix resin is a polymer that includes a hydroxyl group, the stability of the J aggregate of the dye further can be improved. Examples of the matrix resin include polyvinyl alcohol (PVA), a polyethylene-PVA copolymer, a polyvinyl acetate-PVA copolymer, and derivatives of PVA. Examples of the derivatives of PVA include polyvinyl butyral, polyvinyl ethylal, polyvinyl formal, and polyvinyl benzoyl.

The PVA can be obtained by, for example, saponifying a vinyl ester polymer that is obtained by polymerizing vinyl ester monomers. The saponification degree of the PVA is preferably in the range of 95.0 to 99.9 mol %. The use of PVA whose saponification degree is in the above-mentioned range makes it possible to obtain a crosslinked product that has better durability. With respect to the average degree of polymerization of the PVA, a suitable value can be selected suitably according to the intended use. The average degree of polymerization is preferably in the range of 1200 to 3600. The average degree of polymerization can be determined according to, for example, JIS K 6726 (1994 version).

The crosslinked product of the present invention further may contain various additives. Examples of the additives include an antioxidant, ultraviolet absorber, and singlet oxygen scavenger for preventing the dye from deteriorating or refractive index modifiers for providing various functions. One of the above-mentioned additives may be used independently or two or more of them may be used in combination. When consideration is given to the ease of formation of the J aggregate, the amount of the additives to be added is, for example, 50 wt % or less, preferably 30 wt % or less, and more preferably 20 wt % or less with respect to the dye.

The intended use of the crosslinked product of the present invention is not particularly limited and it can be used, for example, for various optical materials. Examples of the optical materials include an ultrafast optical switch, an optical fiber, a sensitizer for silver halide photography, a nonlinear optical material, and an optical filter. Examples of the nonlinear optical material include those that can be used for photonics devices in the optical information processing fields, such as an optical bistable memory, as well as those that provide modulation functions in optical communication and optical circuits. Examples of the optical filter include a color correction filter. The crosslinked product of the present invention is used particularly suitably for the color correction filter.

As described above, the color correction filter of the present invention includes a color correction layer containing the crosslinked product of the present invention, and the half bandwidth at the maximum absorption peak of the color correction layer is preferably in the range of 5 to 30 nm. When the half bandwidth is in the above-mentioned range, it is possible to selectively remove intermediate colors of light without absorbing light (for instance, light of R) in the wavelength ranges that are required for color tone representation. The half bandwidth is more preferably in the range of 7 to 28 nm, further preferably in the range of 8 to 27 nm, and particularly preferably in the range of 8 to 15 nm.

As described above, the wavelength of the maximum absorption peak of the color correction layer is preferably in the range of 560 to 610 nm. When the wavelength of the maximum absorption peak is in the above-mentioned range, for example, the relative emission intensity of light (for example, light of R) required for color tone representation can be prevented from decreasing.

As described above, the maximum absorbance of the color correction layer in a wavelength range of 560 to 610 nm is preferably at least 0.2. The maximum absorbance is more preferably at least 0.8 and further preferably at least 0.9. A person skilled in the art can obtain the maximum absorbance easily by, for example, adjusting the thickness of the color correction layer without requiring excessive trial and error. Furthermore, the absorbance of the color correction layer in the whole wavelength range of 560 to 610 nm is more preferably at least 0.2, further preferably at least 0.8, and particularly preferably at least 0.9. The thickness of the color correction layer is as described above.

The aforementioned color correction filter may be in the form of a composite member in which, for example, the color correction layer is formed on an optical element of the liquid crystal display (LCD) to be described later, for example, a polarizing plate, a retardation plate, or a light guide plate, or may be in the form of a member (independent member) that is independent and separate from those optical elements. In the form of the composite member, the color correction filter may be in the form in which the color correction filter further includes, for example, a base material and the color correction layer is formed on at least one surface of the base material. In this case, the aforementioned form of an independent member embraces, for example, the form in which the color correction filter further includes a base material and the color correction layer is formed on at least one surface of the base material and the form of the above-mentioned independent color correction layer, with the aforementioned color correction layer being separated from the base material. In the form of the independent member, when consideration is given to handleability and thickness of the whole liquid crystal display, the thickness of the whole color correction filter is preferably in the range of 0.1 to 1000 μm. In the form in which further the base material is included, as described later, the color correction filter may be produced by directly forming the color correction layer on at least one surface of the base material or may be produced by bonding the color correction filter, which is the independent member, and the base material to each other with, for example, a pressure sensitive adhesive or an adhesive used therebetween.

Next, a method of forming the color correction layer is described using an example. However, the method of forming the color correction layer is not limited to this example.

First, the aforementioned dye, matrix resin, crosslinker, and if necessary, additives are dissolved uniformly in a solvent and thereby a coating solution for the color correction filter is prepared. Examples of the solvent include water, alcohol, ketone, a chlorinated solvent, a fluorinated solvent, and mixed solvents thereof. The coating solution may be prepared by separately preparing a dye solution obtained by dissolving the dye in the solvent and a resin solution obtained by dissolving the matrix resin and the crosslinker in the solvent and then mixing them together in proper proportions. When the crosslinker is metal alkoxide, it is preferable from the viewpoint of the rate of crosslinking the matrix resin that alcohol be used as the solvent. When alcohol is used as the solvent, for example, an exchange reaction of the matrix resin with a hydroxyl group proceeds as the solvent is removed in the heat-drying step to be described later. As a result, the crosslinking of the matrix resin does not hinder the formation of the J aggregate of the dye, which is preferable. In this case, in order to adjust the reaction rate of the exchange reaction, a small amount of acid, an alkaline compound, or water may be added to the coating solution. In the coating solution, the solid content weight ratio between the dye and the matrix resin is not particularly limited. Furthermore, in the coating solution, the amount of the crosslinker to be mixed is not particularly limited, and it is, for example, in the range of 1 to 200 parts by weight with respect to 100 parts by weight of the matrix resin. When the amount of crosslinker to be mixed is set in the aforementioned range, the crosslinker can be dissolved uniformly in the coating solution, and thereby a sufficiently high effect of crosslinking the matrix resin can be obtained. The amount of the crosslinker to be mixed is preferably in the range of 5 to 150 parts by weight with respect to 100 parts by weight of the matrix resin.

Subsequently, the coating solution is applied onto the optical element of the LCD or the base material and thereby a coating film is formed and is then dried by heating. The J aggregate of the dye is formed in the coating solution or in the aforementioned heat-drying step. The method of applying the coating solution is selected suitably according to, for example, the desired thickness and shape of the color correction layer and the material of the base material. Examples of the method include a spin coating method, a roll coating method, and an applicator coating method. The matrix resin is crosslinked, for example, during or after the aforementioned heat-drying step. Thus, the color correction layer can be formed. Preferably, the matrix resin is crosslinked after formation of the J aggregate of the dye. Furthermore, it is preferable that the matrix resin be crosslinked at a temperature that is equal to or lower than the pyrolysis temperature of the J aggregate of the dye. Since the pyrolysis temperature generally exceeds 100° C., the temperature at which the matrix resin is crosslinked is preferably 100° C. or lower, more preferably 60° C. or lower, and further preferably 30° C. or lower.

In the color correction layer, when the J aggregate of the dye is formed, the light absorption band of the color correction layer shifts to the longer wavelength side and has a reduced width as compared to the case of being free of the J aggregate of the dye contained in the color correction layer (for example, solution state). Thus, it can be judged that the J aggregate of the dye has been formed in the color correction layer.

The color correction filter of the present invention further may contain various additives. Examples of the additives include additives similar to those described above. The amount of the additives to be added can be, for example, the same as that described above. When the color correction filter includes the aforementioned base material, the base material in addition to or instead of the aforementioned crosslinked product may contain the additives.

An example of the color correction filter in the form including the base material is shown in the cross-sectional view in FIG. 2. As shown in FIG. 2, this color correction filter 10 has a base material 11 and a color correction layer 12 as main components. In this example, the color correction layer 12 is formed on one surface of the base material 11. However, the present invention is not limited thereto. In the color correction filter, the color correction layer may be formed on each surface of the base material. Furthermore, in this example, the base material 11 and the color correction layer 12 each are a single layer. However, the present invention is not limited thereto. In the color correction filter, the base material and the color correction layer each may have a plural-layer structure including at least two layers stacked together. When the base material and the color correction layer each have a plural-layer structure, the respective layers of the base material and the color correction layer may be identical to or different from each other. Furthermore, as described above, the color correction filter may be in the form of the independent color correction layer, with the color correction layer being separated from the base material.

The base material is preferably one with excellent optical transparency. The base material may be formed of an organic material or may be formed of an inorganic material. Examples of the organic material include polyacrylic resins, polycarbonate resins, polyvinyl alcohol resins, polyester resins, polyarylate resins, cellulose resins, ionic polymer, and gelatin. Examples of the polyacrylic resins include polymethylmethacrylate, polymethyl acrylate, and polybutyl acrylate. Examples of the polycarbonate resins include polyoxycarbonyloxyhexamethylene and polyoxycarbonyloxy-1,4-isopropylidene-1,4-phenylene. Examples of the polyvinyl alcohol resins include polyvinyl formal, polyvinyl acetal, polyvinyl butyral, polyvinyl alcohol, and an ethylene-vinylalcohol copolymer. Examples of the polyester resins include polybutylene terephthalate and polytetramethyl terephthalate. Examples of the polyarylate resins include polyamide and polyetherimide. Examples of the cellulose resins include methylcellulose, ethylcellulose, and derivatives thereof. Examples of the ionic polymer include polydimethyldiallylammonium chloride. Examples of the inorganic material include silicon oxide glass, titanium oxide, aluminum oxide, zinc oxide, and films formed of hydrolytic condensates of various metal alkoxides. Particularly, among these, polyvinyl alcohol resins, polyacrylic resins, ionic polymer, and gelatin are preferable. The base material may be formed of the independent aforementioned material or may be formed of two or more of the aforementioned materials.

As described above, the base material also may be, for example, a polarizing plate, a retardation plate, or a light guide plate.

The surface shape of the base material may be flat and smooth as shown in FIG. 2 or may be a shape processed for providing it with a certain function. Examples of the shape processed for providing it with a certain function include a prism or lens array shape for improving brightness.

The thickness of the base material is not particularly limited and is, for example, in the range of 5 to 100 μm, preferably in the range of 10 to 90 μm, and more preferably in the range of 20 to 80 μm.

The absorption spectrum, wavelength of the maximum absorption peak, half bandwidth at the maximum absorption peak, and absorbance at the wavelength of the maximum absorption peak of the color correction filter according to the present invention are equal to or nearly equal to the absorption spectrum, wavelength of the maximum absorption peak, half bandwidth at the maximum absorption peak, and absorbance at the wavelength of the maximum absorption peak of the aforementioned color correction layer. Therefore, when the aforementioned characteristics of the color correction layer are measured, the characteristics of the color correction filter including the correction layer can be found out. Similarly, when the aforementioned characteristics of the color correction filter of the present invention are measured, the characteristics of the color correction layer included in the correction filter can be found out.

The color correction filter can be used suitably for various types of image displays, such as a liquid crystal display (LCD) and an EL display (ELD). An example of the configuration of a liquid crystal display including the aforementioned color correction filter used therein is shown in the cross-sectional view in FIG. 3. In FIG. 3, in order to make it clearly understandable, for example, the sizes and ratios of respective components differ from actual ones. As shown in FIG. 3, this liquid crystal display includes the aforementioned color correction filter 10, a liquid crystal panel 41, a light source unit (cold cathode tube) 44, and a light guide plate 45 as main components. The liquid crystal panel 41 is configured with a first polarizing plate 431 and a second polarizing plate 432 that are disposed on the respective sides of a liquid crystal cell 42. The liquid crystal cell 42 includes a liquid crystal layer 440 in the center thereof. A first alignment film 451 and a second alignment film 452 are disposed on both sides of the liquid crystal layer 440, respectively. A first transparent electrode 461 and a second transparent electrode 462 are disposed on the outer sides of the first alignment film 451 and the second alignment film 452, respectively. Color filters 470 with a predetermined arrangement of, for example, R, G, and B, and black matrices 490 are disposed via a protective film 480 on the outer side of the first transparent electrode 461. A first substrate 401 and a second substrate 402 are disposed on the outer sides of the color filters 470 and the black matrices 490, and the second transparent electrode 462, respectively. In the liquid crystal panel 41, the first polarizing plate 431 side is a display side, and the second polarizing plate 432 side is the back side. The light guide plate 45 is disposed, on the back side of the liquid crystal panel 41, in parallel with the liquid crystal panel 41 to lie on top thereof. The light source unit 44 is disposed on the opposite side of the light guide plate 45 to the liquid crystal panel 41. The color correction filter 10 is disposed on the outer side of the first polarizing plate 431 (on the upper side in FIG. 3). However, in the liquid crystal display of the present invention, the position where the color correction filter is disposed is not limited to this example. In the present invention, the color correction filter 10 can be disposed in any position between the light source unit 44 and the surface of the liquid crystal display located on the display side (on the upper side in FIG. 3). The position where the color correction filter 10 is disposed is located preferably between the light source unit 44 and the light guide plate 45, between the light guide plate 45 and the liquid crystal panel 41, between the second polarizing plate 432 and the liquid crystal cell 42, or on the outer side (on the upper side in FIG. 3) of the first polarizing plate 431, and more preferably between the light guide plate 45 and the liquid crystal panel 41 or on the outer side (on the upper side in FIG. 3) of the first polarizing plate 431. Furthermore, the liquid crystal display of this example includes one color correction filter 10. However, the present invention is not limited thereto. A liquid crystal display of the present invention may include a plurality of the color correction filters.

In the liquid crystal display of this example, color tone representation is improved, for example, as follows. The cold cathode tube 44 has an emission peak of B around a wavelength 435 to 480 nm, that of G around a wavelength of 500 to 560 nm, and that of R around a wavelength of 610 to 750 nm. In this case, the color correction filter 10 used herein is one in which the wavelength of the maximum absorption peak of the color correction layer is in the range of 560 to 610 nm. This allows light with wavelengths in the range of 560 to 610 nm to be absorbed selectively by the color correction filter 10 to be removed. Accordingly, the color tone representation of light (particularly, light of R) emitted from the cold cathode tube 44 can be improved. Furthermore, in the color correction filter 10, since the matrix resin has been crosslinked, it has better heat resistance. Moreover, when, for example, a color correction filter in which the half bandwidth at the maximum absorption peak of the color correction layer is very narrow, specifically, in the range of 5 to 30 nm, is used for the liquid crystal display of this example, it is possible to prevent brightness from deteriorating without absorbing light (for example, light of R) in the wavelength range required for color tone representation.

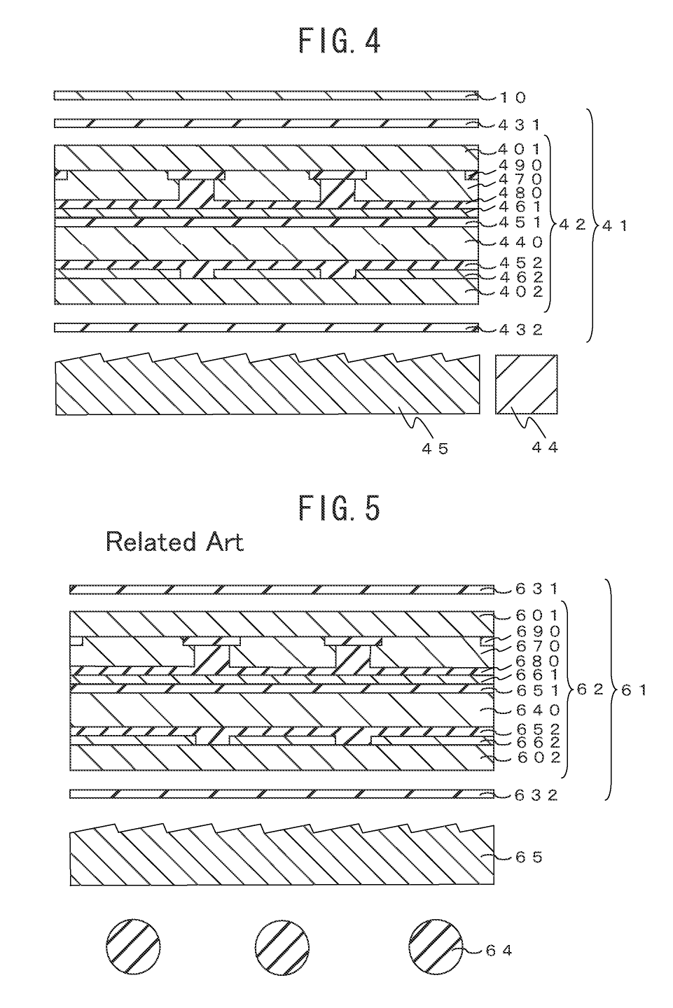

Another example of the configuration of a liquid crystal display including the color correction filter used therein is shown in the cross-sectional view in FIG. 4. In FIG. 4, the identical parts to those shown in FIG. 3 are indicated with identical numerals. In the liquid crystal display of this example, the light source unit 44 is a pseudo white light source that produces white light from light emitted from a blue LED and yellow light emitted from YAG. The light source unit 44 is disposed beside the light guide plate 45 (on the right side thereof in FIG. 4). Except for these, the liquid crystal display of this example has the same configuration as that of the liquid crystal display shown in FIG. 3. As described above, the pseudo white light source contains more intermediate colors of light as compared to the cold cathode tube. However, in the liquid crystal display of the present invention, even in the case of using the pseudo white light source, since the color correction filter 10 absorbs the intermediate colors of light selectively to remove them, it is possible to improve color tone representation while preventing brightness from deteriorating.

The liquid crystal display of the present invention is not limited to the examples shown in FIGS. 3 and 4. For instance, the liquid crystal display of the present invention further may include various optical elements such as a retardation film, a diffuser plate, an antiglare layer, an antireflection layer, a protective plate, a prism array, and a lens array sheet. The optical elements may be, for example, optical elements of the present invention.

The image display of the present invention is used for any suitable applications. Non-limiting examples of the applications include office equipment such as a desktop PC, a notebook PC, and a copy machine, portable devices such as a mobile phone, a watch, a digital camera, a personal digital assistant (PDA), and a handheld game machine, home electric appliances such as a video camera, a television set, and a microwave oven, vehicle equipment such as a back monitor, a monitor for a car-navigation system, and a car audio, display equipment such as an information monitor for stores, security equipment such as a surveillance monitor, and nursing and medical equipment such as a monitor for nursing care and a monitor for medical use.

### Examples

Next, examples of the present invention are described together with comparative examples. The present invention is neither limited nor restricted by the following examples or comparative examples. Measurement and evaluation of various characteristics and physical properties in the respective examples and comparative examples were carried out by the following methods.

### (1) Absorption Spectra, Wavelengths of Maximum Absorption Peaks, Half Bandwidths at Maximum Absorption Peaks, and Absorbance at Wavelengths of Maximum Absorption Peaks of Dye Solution, Color Correction Layer, and Color Correction Filter

Absorption spectra of the dye solution, color correction layer, and color correction filter were measured using an ultraviolet-visible spectrophotometer (“V-560” (trade name), manufactured by Jasco Corporation). From the absorption spectra thus measured, the wavelengths of the maximum absorption peaks, half bandwidths at the maximum absorption peaks, and absorbance at the wavelengths of the maximum absorption peaks of the dye solution, color correction layer, and color correction filter were determined.

### (2) Heat Resistance of Color Correction Filter

The heat resistance of the color correction filter was evaluated by measuring the change in absorbance of the color correction filter with time in an 85° C. environment (in a dryer). The measurement of the absorbance was carried out at a room temperature using the ultraviolet-visible spectrophotometer.

### Example 1

### <Preparation of Dye Solution>

0.13 g of dye (1-ethyl-2-[(1-ethyl-2(1H)-quinolinylidene)methyl]quinolinium bromide (manufactured by Hayashibara Biochemical Labs., Inc.)), Br⁻ salt of an ion represented by structural formula (5) described above, was dissolved in 100 mL of solvent and thereby 1.3 g/L (0.14 wt %) of dye solution was obtained. The solvent used herein was a mixed solution of water and ethanol (water/ethanol=1/1 (wt %)).

### <Preparation of Resin Solution>

39 g of PVA (with a polymerization degree of 1800 and a saponification degree of 98.0 to 99.0 mol %, manufactured by The Nippon Synthetic Chemical Industry Co., Ltd.) was added to and dissolved in 961 g of warm water by stirring and thereby 3.9 wt % of aqueous solution was obtained. Furthermore, 2.4 g of zinc chloride was added, as a crosslinker, to 100 g of the aqueous solution and was dissolved therein. Thus a resin solution was obtained.

### <Preparation of Coating Solution for Color Correction Filter>

5 g of the aforementioned dye solution and 1 g of the aforementioned resin solution were mixed together and were dissolved. Thus a coating solution for a color correction filter was obtained.

### <Production of Color Correction Filter>

With the coating solution being allowed to drip onto a base material (a glass sheet, 50 mm long×45 mm wide×1 mm thick), coating was carried out by the spin coating method under a condition of 1000 times/min×30 sec and thereby a coating film was formed. This was then dried and PVA was crosslinked. In this case, the drying temperature was 80° C. In this manner, a color correction layer that included a crosslinked product containing the aforementioned J aggregate of the dye was formed on one surface of the base material and thereby the color correction filter of this example was obtained. The wavelength of the maximum absorption peak of the color correction layer was 577 nm, the half bandwidth at the maximum absorption peak was 7 nm, and the absorbance at the wavelength of the maximum absorption peak was 0.4. Furthermore, the thickness of this color correction layer was 200 nm.

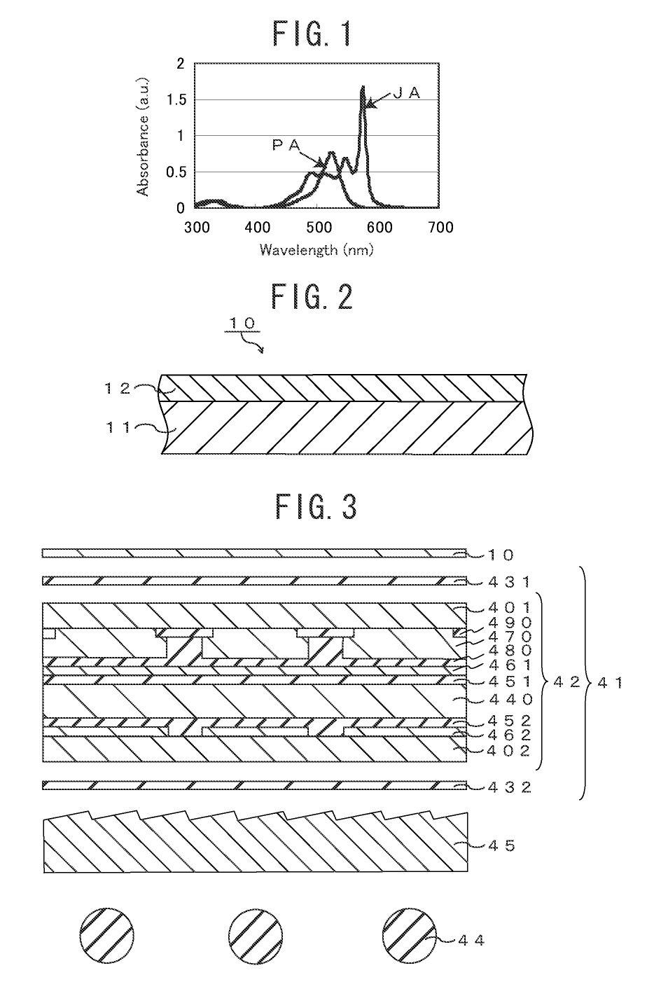

The absorption spectra of the dye solution and the color correction layer are shown in the graph in FIG. 1. In FIG. 1, PA indicates the absorption spectrum of the dye solution and JA the absorption spectrum of the color correction layer. As shown in FIG. 1, the wavelength (577 nm) of the maximum absorption peak of the color correction layer was located on the longer wavelength side than the wavelength (523 nm) of the maximum absorption peak of the dye solution. Furthermore, the half bandwidth (7 nm) at the maximum absorption peak of the color correction layer was narrower than the half bandwidth (34 nm) at the maximum absorption peak of the dye solution. Thus, it was judged that the J aggregate of the dye had been formed in the color correction layer.

### Example 2

A color correction filter of this example was obtained in the same manner as in Example 1 except that 0.39 g of ferric chloride hexahydrate was used as a crosslinker.

### Example 3

A color correction filter of this example was obtained in the same manner as in Example 1 except that 0.39 g of boric acid was used as a crosslinker.

### Comparative Example 1

A color correction filter of this comparative example was obtained in the same manner as in Example 1 except that no crosslinker was used.

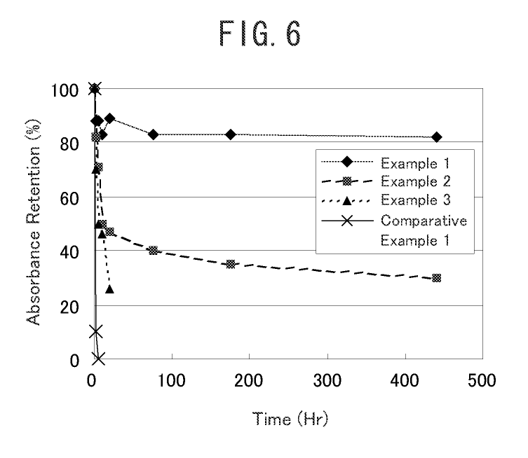

The heat resistance evaluation results of Examples 1 to 3 and Comparative Example 1 are shown in FIG. 6. In FIG. 6, the change in absorbance retention (%) with time is indicated, with the initial value (0 hour) of the absorbance at the wavelength of the maximum absorption peak of the color correction filter being taken as a reference (100%). In Example 1, the absorbance obtained after 440 hours was 0.33 and the retention thereof was 83%. In Example 2, the absorbance retention obtained after 440 hours was 30%. In Example 3, the absorbance retention obtained after 20 hours was 26%. On the other hand, in Comparative Example 1, the absorbance retention obtained after 5 hours was 0%. Thus, in Examples 1 to 3, the color correction filters had improved heat resistance as compared to Comparative Example 1 in which no crosslinker was used.

### INDUSTRIAL APPLICABILITY

As described above, the crosslinked product of the present invention can remove intermediate colors of light while preventing brightness from deteriorating, can improve color tone representation, and has excellent durability. Examples of the applications of the crosslinked product and the color correction filter using the same as well as the image display of the present invention include office equipment such as a desktop PC, a notebook PC, and a copy machine, portable devices such as a mobile phone, a watch, a digital camera, a personal digital assistant (PDA), and a handheld game machine, home electric appliances such as a video camera, a television set, and a microwave oven, vehicle equipment such as a back monitor, a monitor for a car-navigation system, and a car audio, display equipment such as an information monitor for stores, security equipment such as a surveillance monitor, and nursing and medical equipment such as a monitor for nursing care and a monitor for medical use. However, the applications thereof are not limited and they are applicable to a wide range of fields.

1. A crosslinked product, comprising a J aggregate of a dye,
wherein the dye is at least one dye selected from the group consisting of cyanine, merocyanine, squarylium, and porphyrin, and
the J aggregate of the dye is formed in a matrix resin and the matrix resin has been crosslinked.

2. The crosslinked product according to claim 1, wherein the matrix resin has been crosslinked at a temperature that is equal to or lower than pyrolysis temperature of the J aggregate of the dye.

3. The crosslinked product according to claim 1, wherein the matrix resin is a polymer that includes a hydroxyl group, and the matrix resin has been crosslinked with the hydroxyl group and a crosslinker.

4. The crosslinked product according to claim 3, wherein the crosslinker is at least one crosslinker selected from the group consisting of metal salt, boric acid, and a silane compound.

5. The crosslinked product according to claim 4, wherein the metal salt contains at least one metal selected from the group consisting of zinc, titanium, zirconium, iron, aluminum, and tin.

6. The crosslinked product according to claim 4, wherein the metal salt contains zinc.

7. The crosslinked product according to claim 1, wherein the matrix resin is at least one selected from the group consisting of polyvinyl alcohol, a polyethylene-polyvinyl alcohol copolymer, a polyvinyl acetate-polyvinyl alcohol copolymer, and a derivative of polyvinyl alcohol.

8. The crosslinked product according to claim 1, wherein the dye is cyanine.

9. The crosslinked product according to claim 8, wherein the cyanine is represented by at least one formula selected from the group consisting of the following general formulae (1) to (4): 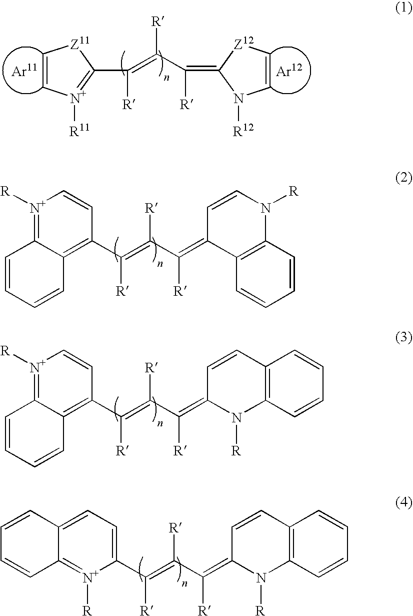
where in general formula (1), Z¹¹ and Z¹² each are —NH—, —CH₂—, —CH═CH—, or a heteroatom and optionally have a substituent, and Z¹¹ and Z¹² are identical to or different from each other,
the rings Ar¹¹ and Ar¹² each optionally have an unsaturated bond in a region other than a condensation portion formed with a nitrogen-containing ring, optionally have aromaticity, optionally have a heteroatom, and further optionally have a substituent, and the rings Ar¹¹ and Ar¹² are be identical to or different from each other,
R¹¹ and R¹² each are a hydrogen atom or a linear or branched alkyl group, the alkyl group is further optionally substituted by an ionic substituent, and R¹¹ and R¹² are identical to or different from each other,
in general formulae (2) to (4),
R is a hydrogen atom or a linear or branched alkyl group, and the respective Rs are identical to or different from each other, and
in general formulae (1) to (4),
R′ is a hydrogen atom, a linear or branched alkyl group, or an aromatic group, and the respective R′s are identical to or different from each other, and
n is 0 or a positive integer.

10. The crosslinked product according to claim 9, wherein the cyanine is represented by at least one formula selected from the group consisting of the following structural formulae (5) to (7): 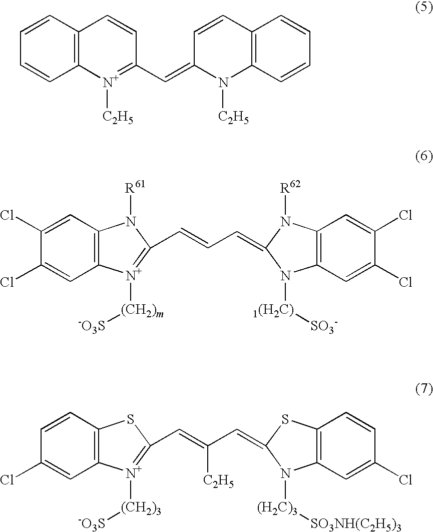
in structural formula (6),
R⁶¹ and R⁶² each are a hydrogen atom or a linear or branched alkyl group, and R⁶¹ and R⁶² are identical to or different from each other, and
m and 1 each are a positive integer and they may be identical to or different from each other.

11. A color correction filter, comprising a color correction layer containing the crosslinked product according to claim 1.

12. The color correction filter according to claim 11, wherein half bandwidth at a maximum absorption peak of the color correction layer is in a range of 5 to 30 nm.

13. The color correction filter according to claim 11, wherein the wavelength of the maximum absorption peak of the color correction layer is in a range of 560 to 610 nm.

14. The color correction filter according to claim 11, wherein the maximum absorbance of the color correction layer in a wavelength range of 560 to 610 nm is 0.2 or more.

15. The color correction filter according to claim 11, wherein the color correction layer has a thickness in a range of 10 to 500 nm.

16. The color correction filter according to claim 11, further comprising a base material,
wherein the color correction layer is formed on at least one surface of the base material.

17. An optical element, comprising the color correction filter according to claim 11.

18. An image display, comprising the color correction filter according to claim 11.

19. A liquid crystal display, comprising the color correction filter according to claim 11.

20. An image display, comprising the optical element according to claim 17.

21. A liquid crystal display, comprising the optical element according to claim 17.
